(19) United States
(12) Patent Application Publication
(10) Pub. No.: US 2014/0313033 A1
(43) Pub. Date: Oct. 23, 2014

(54) DECORATIVE EYEGLASSES LOCATOR

(71) Applicant: Dafna Ariely, Caesarea (IL)

(72) Inventor: Dafna Ariely, Caesarea (IL)

(21) Appl. No.: 14/362,992

(22) PCT Filed: Dec. 6, 2012
(86) PCT No.: PCT/IL2012/050515

§ 371 Date: Jun. 5, 2014

Related U.S. Application Data
(60) Provisional application No. 61/567,134, filed on Dec. 6, 2011.

(51) Int. Cl. G08B 21/24

(52) U.S. Cl. CPC G08B 21/24
USPC 340/539.32

(57) ABSTRACT

A system for locating an item, comprising a locator device, the locator device comprises at least a receiver, an alarm module and a connector to attach the locator device to an item; and a transmitter to generate a pre-selected signal to be received by the receiver once the receiver is within a reception range from said transmitter, wherein the receiver is to actuate the alarm module once the pre-selected signal is received.

### FIELD OF THE INVENTION

The subject matter relates generally to a device to locate misplaced items, and more particularly to an eyeglasses locator.

### BACKGROUND OF THE INVENTION

Few known devices are utilized for finding misplaced items. Some of these known devices are aimed particularly to locate misplaced eyeglasses. Typically, devices for locating misplaced eyeglasses are configured to be installed in a casing unit at a distal end of an eyeglasses arm and are not utilized as ornaments for the eyeglasses. Typically, the casing unit is not usable with generic eyeglasses. Some types of locators are embedded with the glasses frame or with a part of a glasses frame, and are not removable and/or replaceable, and/or require specially designed eyeglasses. Additionally, some of the eyeglasses locators are located and/or designed in a manner that may harm the glasses or the frame and/or their functionality.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a system for locating an item according to embodiments of the present invention; and

FIGS. 2A, 2B, and 2C are schematic illustrations of devices for locating an item according to embodiments of the present invention, which may be attached to a temple arm of eyeglasses, camouflaged as an ornament or embedded within the eyeglasses arm.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Embodiments of the present invention may provide a user with a friendly search and locating system and device for finding a misplaced small item such as eyeglasses, wherein a receiver casing attached to the item may be designed as decoration such as, for example, jewelry. In some embodiments, the locator may be designed and/or located to not harm the design and functionality of the glasses and/or glasses frame. The locating system may include at least one receiver and at least one transmitter, wherein the receiver may typically be housed within a decorative case and/or camouflaged in the inner side of the frame. The receivers may be advance technology receivers and therefore may have light weight and small size, which may enable, for example, the use of various designs for the receiver casing. The case may be designed as a jewelry complimenting the eyeglasses design and function and/or camouflaged in the inner side of the frame.

It is therefore an advantage of the present invention to provide a user friendly apparatus for locating a pair of eyeglasses configured as add-on element to be used as a jewelry, wherein the ornament cases the locator receiver. It is another advantage of the present invention to provide a design for securing attachment of the add-on ornament element, enabling easy remove and secure from the eyeglasses frame. Typically, the locator devices may be attached to the glasses frame by sticking the locator with a sticking tape, which may enable easy removal of locator device 10, if needed. Moreover, it is advantage to design a small size and weight receiver, to fill the requirements of eyeglasses as an optical system and as eyewear element.

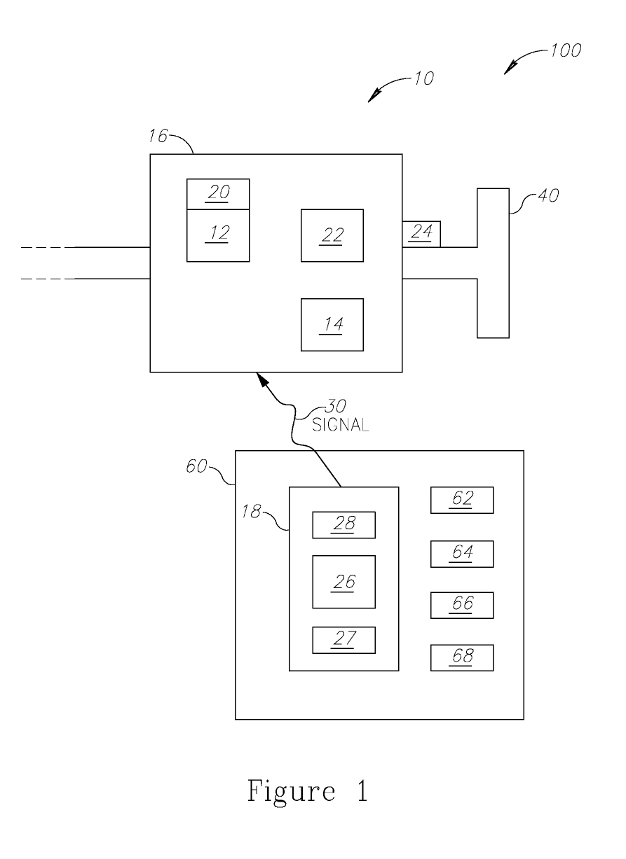

Reference is now made to FIG. 1, which is a schematic illustration of a system 100 for locating an item according to embodiments of the present invention. System 100 may include a locator device 10 and a transmitter 18. Locator device 10 may include a receiver 12, an alarm module 14, a case 16, which may encase receiver 12 and/or alarm module 14, an antenna 20, a power source 22 and a connector 24 to attach device 10 to an item 40, for example a glasses, keys, a cell phone, a wallet etc.

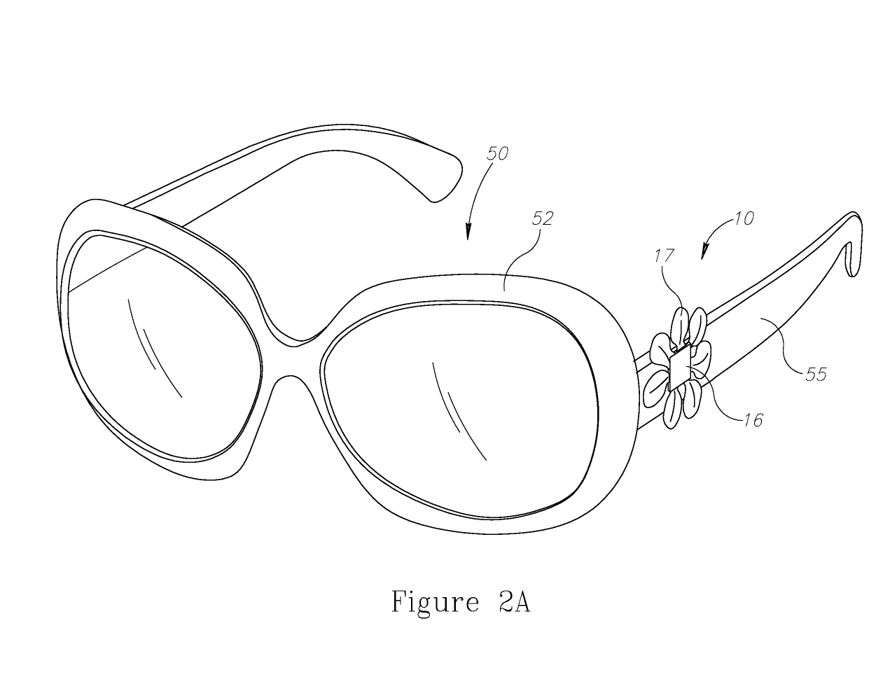

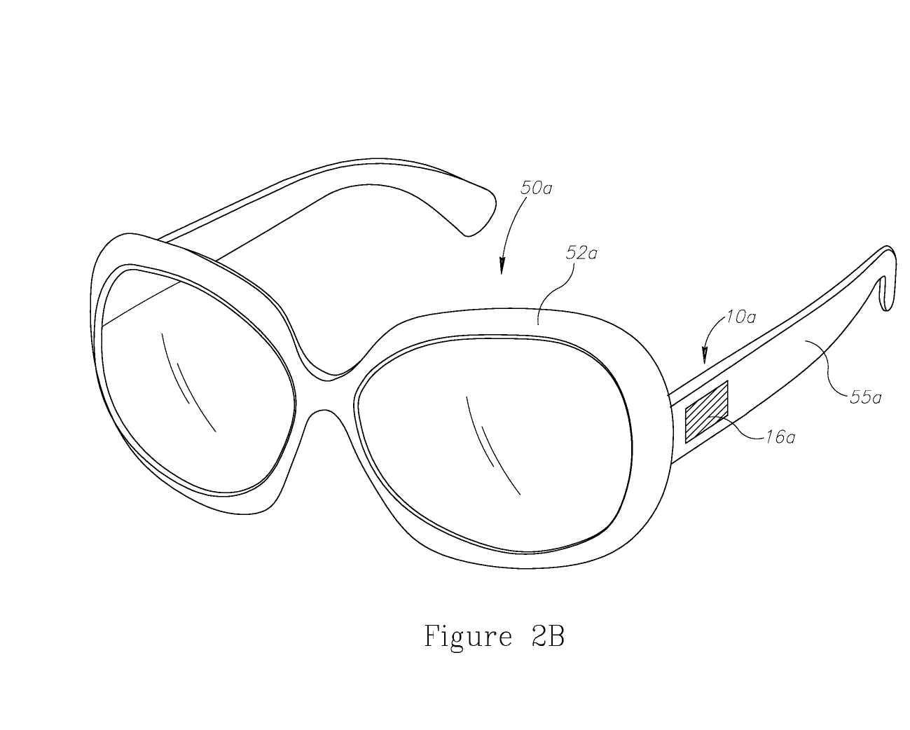

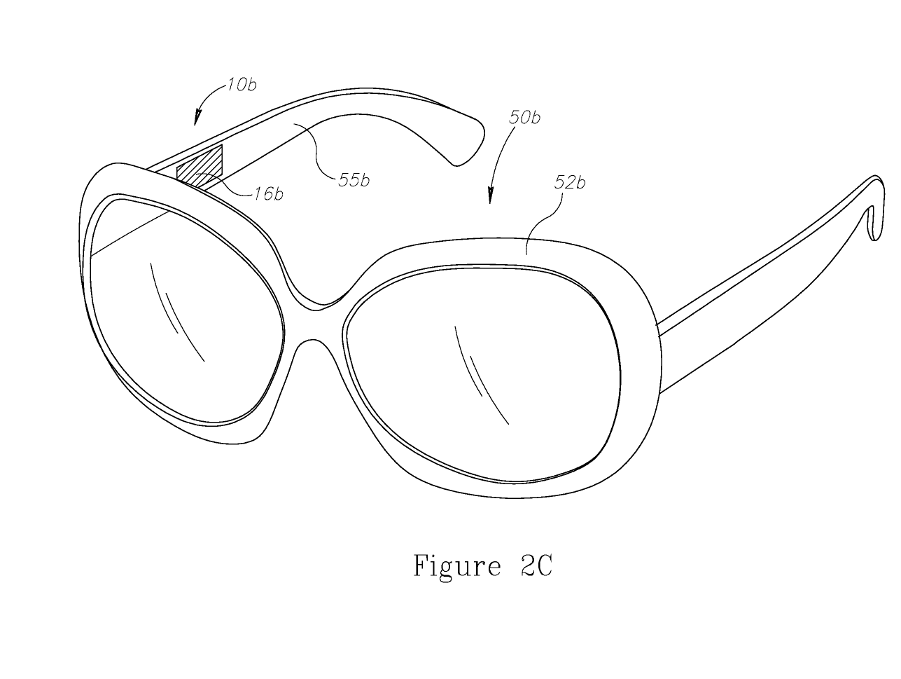

In some embodiments, case 16 may be designed as ornamentation and/or include an ornament with the eyeglass. Typically, As shown in FIGS. 2A, 2B or 2C, the locator case 16 16 or 16b may be designed to be camouflaged in the internal side of the glasses temple arms, as an ornament or embedded within the eyeglasses arm (see case 16a in FIG. 2B or 16b in FIG. 2C). Typically, case 16 or 16a may be located on or within one of the glasses temple arms (in the internal or external side), for example at the region located against the temple of the wearer, when the eyeglasses are worn, as shown, for example, in FIGS. 2A, 2B and 2C. Case 16 may be securable to item 40, for example by connector 24, which may attach case 16 to item 40 by hanging, adhering, clip-on, snap-on, and/or any other suitable manner Case 16 may be made at various shapes and/or sizes, for example so as to enable housing of the modules of device 10. The possibility to design case 16 in various sizes may be enabled due to a relative small size and/or light weight of receiver 12.

Case 16 may be designed and/or include an ornament (for example, as shown in FIG. 2A) in various styles such as, for example, eyeglasses jewelry. Thus, for example, case 16 may be designed and/or include an ornament (shown in FIG. 2A) to disguise device 10 as an ornament with an eyeglasses. The design of case 16 and/or the included ornament may enable device 10 to be complementary with the eyeglass and thus, for example, may integrate with and/or not interfere with eyeglasses design and function. The variety of design possibilities that may be enabled, for example, due to the small size and/or weight of receiver 12, may include variety of styles such as, for example, from relatively small and unnoticeable design, to relatively big and fashionable design.

Optionally, system 100 may include an additional case (not shown) similar to case 16 such as, for example, a mock-up case, to be attached to a second temple arm of a pair of eyeglasses. In some embodiments, the additional case may include another receiver and/or another alarm module and, for example, may function similarly to the first case 16. In some embodiments, the additional case may encase spare parts such as, for example, a spare power source, for example, a battery, that may be taken out of the additional case and inserted into case 16. In some embodiments of the present invention, case 16 and/or an additional case may include removable parts, for example, that may be replaced and thus, for example, match the exact style and design of the eyeglasses, such as, for example, a part that includes a logo.

Transmitter 18 may be included, for example, in a remote control and/or in a mobile device such as, for example, a tablet computer, a cellular phone or a smartphone device 60. Transmitter 18 may include, for example, a signal generator 26, a power source 27 and an antenna 28. Transmitter 18 may be included, for example, in a mobile device 60 such as, for example, a dedicated remote, cellular phone, smartphone, tablet computer, flashlight, car alarm transmitter, TV remote, WIFI module, GSM module, Bluetooth module and/or any other transmitter and/or in any other communication device or other device that can send a signal, using, for example, short-range communication. Transmitter 18 may be synchronized with receiver 12, for example to generate and/or transmit a pre-selected signal 30, for example by signal generator 26. Pre-selected signal may be received by receiver 12, for example once receiver 12 is within a reception range from transmitter 18. Receiver 12 may identify whether signal 30 is a pre-selected signal. Once receiving pre-selected signal 30, receiver 12 may actuate alarm module 14 to produce a voice and/or visual alarm, for example in order to draw a user's attention to the location of device 10 and thus, for example, to the location of item 40. In some embodiments of the present invention, transmitter 18 may be synchronized with additional receivers and/or receiver 12 may be synchronized with additional transmitters.

As mentioned above, in some embodiments of the present application, transmitter 18 may be included in a smartphone or tablet or other mobile device 60, which may further include a display 62, memory 64, a processor 66 and a user interface 68. Memory 64 may include an article such as a computer or processor readable non-transitory storage medium, such as for example a memory card, a disk drive, or a USB flash memory encoding, including or storing instructions, e.g., computer-executable instructions, such as, for example, application/software items downloaded from an application server. When executed by a processor or controller such as processor 66, the instructions stored and/or included in memory 64 may cause the processor or controller to carry out methods disclosed herein.

Application/software items for the smartphone/tablet, according to embodiments of the present invention, may be downloaded and stored in memory 64 automatically or following a user command entered by user interface 68. According to embodiments of the present invention, transmitter 18 may transmit a pre-selected signal 30, for example by signal generator 26. Pre-selected signal may be received by receiver 12, for example once receiver 12 is within a reception range from transmitter 18. Receiver 12 may identify whether signal 30 is a pre-selected signal. Once receiving pre-selected signal 30, receiver 12 may actuate alarm module 14 to produce a voice and/or visual alarm, for example in order to draw a user's attention to the location of device 10 and thus, for example, to the location of item 40. Additionally or alternatively, receiver 12 may send a feedback signal back to transmitter 18. Mobile device 60 may estimate the distance and/or may sense changes in distance from locator device 10, and/or may sense when mobile device 60 is taken further away from or towards locator device 10, for example based on the strength of the feedback signal received from locator device 10. According to the changes in distance from locator device 10, mobile device 60 may generate vocal and/or visual indications and/or notifications to notify a user of the changes in distance from locator device 10. Thus, a user may identify were he should go in order to find, for example, item 40.

Reference is now made to FIGS. 2A and 2B, which are schematic illustrations of device 10 or 10a for locating an item according to embodiments of the present invention, described in detail above, which may be attached to an eyeglasses temple arm 55 or 55a of eyeglasses 50 or 50a. In FIG. 2A, case 16 may include a decorative ornament shape and/or may carry a decorative ornament 17 such as, for example a flower shaped ornament or any other suitable shape. As discussed above, case 16 may typically be secured to temple arm 55 by connector 24, which may attach case 16 to temple arm 55 by hanging, adhering, clip-on, snap-on and/or any other suitable attachment method, temporary or fixed. Case 16 may be configured for easy and simple removal from the arm 55 by connector 24.

According to embodiments of the present invention, case 16 may be attached to arm 55 by connector 24, for example, so as to minimize the disturbance that may be caused to a field of view of a potential wearer of glasses 50 and or to the wearing convenience and/or proper fit of glasses 55. As shown in FIG. 2A, for example in order to achieve minimal disturbance by case 16, a typical location for attachment of case 16 to arm 55 may be in a region of arm 55 between a location on arm 55 to be supported by a ear of a wearer and a connection of arm 55 with lens frame 52, for example relatively close to a lens frame 52 of glasses 50. Additionally as shown in FIG. 2A, a preferable location for attachment of case 16 may be in an internal side of arm 55, e.g. the side facing the wearer when the glasses are worn. Accordingly, in embodiments of the present invention, connector 24 may be configured to attach case 16, and thus, for example, to attach locator device 10, to a frontal segment of temple arm 55 of eyeglasses 55, for example close to lens frame 52. Additionally, connector 24 may be configured to attach case 16, and thus, for example, to attach locator device 10, to an internal side temple arm 55.

As shown in FIG. 2B and 2C, case 16a or 16b, which may be similar, function similarly and/or include similar elements to case 16, may be embedded within arm 55a/b of eyeglasses 50a/b. As shown in FIG. 2B, for example in order to achieve minimal disturbance by case 16a and/or, for example, minimal disturbance to communications with receiver 12 included in case 16a, a typical location for embedding case 16a within arm 55a may be in a region of arm 55a between a location in arm 55a to be supported by a ear of a wearer and a connection of arm 55a with lens frame 52a, for example relatively close to a lens frame 52a of glasses 50a. Additionally as shown in FIG. 2B, a preferable location for embedding case 16a may be in an internal side of arm 55a, e.g. the side facing the wearer when the glasses are worn.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1-15. (canceled)

16. A system for locating an item, the system comprising:
a locator device attachable to eyeglasses, the locator device comprises at least a receiver and an alarm module;
a connector configured to attach said locator device to said eyeglasses;
an ornament shaped to disguise said locator device as an ornament of said eyeglasses; and
a transmitter configured to generate a pre-selected signal to be received by said receiver once said receiver is attached to said eyeglasses and further within a reception range from said transmitter,
wherein said receiver is configured to actuate said alarm module once the preselected signal is received.

17. The system according to claim 16, wherein the connector and the ornament form a single element.

18. The system according to claim 16, wherein said connector is configured to attach the locator device to a frontal segment of a temple arm of said eyeglasses close to a lens frame of said eyeglasses.

19. The system of claim 16, wherein said connector is configured to attach the locator device to an internal or external side said temple arm.

20. The system of claim 16, wherein said transmitter is included in a mobile communication device configured to send a short-range communication signal.

21. The system of claim 20, wherein said mobile device is selected from the group consisting of a dedicated remote, a cellular phone, a smartphone, a tablet computer, a flashlight, a car alarm transmitter, a TV remote, a Wi-Fi module, a GSM module and a Bluetooth module.

22. The system of claim 20, wherein said mobile device comprises a processor, said processor configured to: receive a feedback signal from said receiver; sense changes at a distance from said locator device; and generate indications to notify a user of the changes at a distance from said locator device.

23. A locater device comprising:
a housing attachable to eyeglasses;
a receiver;
an alarm module;
a connector configured to attach said housing to said eyeglasses; and
an ornament shaped to disguise said locator device as an ornament of said eyeglasses; and
wherein said receiver is configured to actuate said alarm module once a preselected signal transmitted from a transmitter located within a reception range is received.

24. The locater device according to claim 23, wherein the connector and the ornament form a single element.

25. The locater device according to claim 23, wherein said connector is configured to attach the locator device to a frontal segment of a temple arm of said eyeglasses close to a lens frame of said eyeglasses.

26. The locater device of claim 23, wherein said connector is configured to attach the locator device to an internal or external side said temple arm.

27. The locater device of claim 23, wherein said transmitter is included in a mobile communication device configured to send a short-range communication signal.

28. The locater device of claim 27, wherein said mobile device is selected from the group consisting of a dedicated remote, a cellular phone, a smartphone, a tablet computer, a flashlight, a car alarm transmitter, a TV remote, a Wi-Fi module, a GSM module and a Bluetooth module.

29. The locater device of claim 27, wherein said mobile device comprises a processor, said processor is configured to:
receive a feedback signal from said receiver; sense changes at a distance from said locator device; and
generate indications to notify a user of the changes at a distance from said locator device.
